(19) United States
(12) Patent Application Publication
(10) Pub. No.: US 2023/0062260 A1
(43) Pub. Date: Mar. 2, 2023

(54) AUXILIARY SHEET-METAL WORKING DEVICE

(71) Applicant: BOSSAUTO INNOVA, S.A.U., La Roca del Vallès Barcelona (ES)

(72) Inventor: David GALINDO HUERTA, Tavernes Blanques (ES)

(21) Appl. No.: 17/798,976

(22) PCT Filed: Sep. 2, 2020
(86) PCT No.: PCT/IB2020/058150

§ 371 Date: Aug. 11, 2022

(30) Foreign Application Priority Data
Feb. 21, 2020 (ES) U202030297

(51) Int. Cl. B25B 11/00; B43L 7/00

(52) U.S. Cl. CPC B25B 11/002; B43L 7/005; B43L 7/007

(57) ABSTRACT

An auxiliary sheet-metal working device facilitates the completion of bodywork repair and painting operations with the affixing of anagrams, logos and any kind of indications. For this purpose, the device can include a flat platform with one or more rulers on at least one straight edge. In certain embodiments, the auxiliary sheet-metal working device can include at least one movable and/or removable ruler.

### TECHNICAL FIELD

The application relates to an auxiliary sheet-metal working device which facilitates the completion of the bodywork repair and painting operations with the affixing of anagrams, logos and any kind of indications.

It is applicable in the field of repair of vehicles and other bodywork objects.

### STATE OF THE ART

When repairing the body of a vehicle or another bodywork element, logos, names of the model or indications of another type must often be removed. These indications can have a single body, in which case the removal and repositioning thereof are simple. However, it may also correspond to several separate letters or signs which must be affixed later in the exact position. Controlling the position is complex and requires time and skilled workforce.

It is particularly complicated to affix them again in the same location and maintaining the alignment and kerning between the letters. The affixing is often deficient and has a negative impact on the aesthetic aspect to be repaired.

Therefore, the choice of replacing it with a new element is selected, which involves a considerable increase in the cost of the repair.

The applicant does not know of any device similar to the invention.

### SUMMARY OF THE INVENTION

The invention consists of an auxiliary sheet-metal working device. The numerous variants thereof overcome the problems described.

It is a device that allows the indications to be correctly affixed and positioned with the same contour heights or measurements they had before they were taken off the vehicle, so that the finish is perfect, and the process is simple, quick, and effective.

The auxiliary sheet-metal working device is designed to secure the relative position of the signs forming an indication to be positioned on the bodywork or any element of the vehicle. It comprises a flat platform with one or more rulers on at least one straight edge, preferably more than one and with said ruler(s) being movable and/or removable.

The platform can be markable. It can also have a magnetic surface for fixing the rulers or other elements, including the indication. If the ferromagnetic elements of the indication are to be fixed, which is not very common, the magnetic surface will preferably have a force of between 50 and 300 Gauss.

The presence of the ruler on an edge allows the relative position of the signs to be secured. However, it is more convenient to have a mould with the negative of all or part of the signs of the indication. Affixing is, therefore, quicker and more precise.

The device has a carrier, removable from the platform, which temporarily fixes the indication and allows the separation thereof from the platform. For example, to include it on or fix it to the bodywork or any element of the vehicle.

Other variants can be seen in the rest of the specification.

### DESCRIPTION OF THE FIGURES

To better understand the invention, the following figures are included.

FIG. 1 shows a perspective view of an embodiment with a movable arm and a fixed arm.

FIG. 2 shows a perspective view of a similar example using a mould, halfway through removing the sign with the carrier.

### EMBODIMENTS OF THE INVENTION

An embodiment of the invention is briefly described below as an illustrative and non-limiting example thereof.

The embodiment is based on a flat platform (1), preferably with a shoulder. The platform (1) can have a markable surface, i.e., a surface that can be written on or marked. For example, it can have a surface for writing with erasable markers, such as Velleda markers, a registered trademark. The platform (1) can also be magnetic to facilitate the temporary adhesion of ferromagnetic indications (2). In that case, the power of the magnet will be relatively small, for example 50-300 Gauss, so that it is easy to remove the indications (2) later.

The platform (1) has at least one ruler (3), which can be removable. The ruler (3) will mainly be on a straight edge of the platform (1). If the platform is inclined, that edge will be the lower edge. If two rulers (3) are arranged, at least one will be movable or removable to be adjusted to the different heights of the indications (2).

The presence of two rulers (3), one on each side of the indication (2), allows the upper and lower ends of the signs (21) forming the indication (2) to be delimited. These can be moved over the platform (1) to complete the adjustment of the relative position, measured by the rulers (3), and assuring any necessary symmetry.

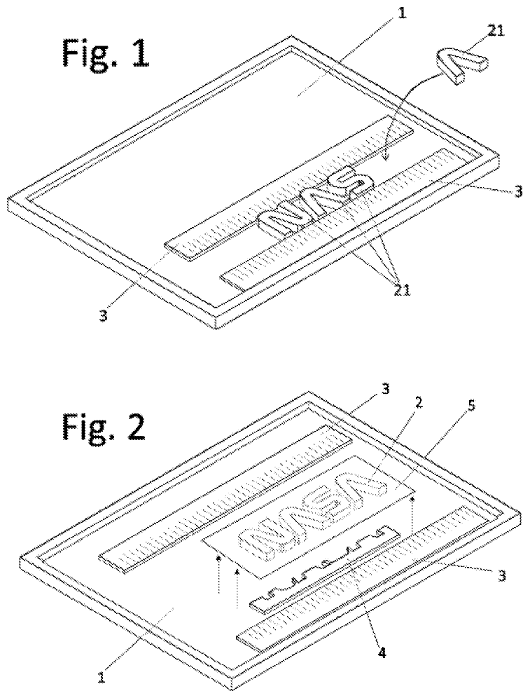

FIG. 1 shows the affixing of several signs (21) of an indication (2). The ruler (3) is on the lower edge of platform (1), and the three first signs (21) have already been affixed. The kerning between the signs (21) can be measured with the ruler (3) to be kept constant. The kerning may have been measured on the vehicle or object to be repaired before removing the indication (2) or arranging boards.

It is possible to arrange moulds (4) in which the different signs (21) or parts of the indications (2) have been cut out to ensure the exact position. Mould (4) may include only part of the signs (21) if it is enough to suitably align and kern the indication (2) (FIG. 2). Moulds (4) will be designed for every possible indication (2) (“Renault”, “Seat Cordoba”, etc.). Since the number of possible indications (2) is very high, it is only logistically applicable for the most common indications (2).

Once all signs (21) are affixed on the platform (1) in the correct position, a carrier (5) can be used to temporarily fix the signs (21) in position and affix it on the vehicle. Carrier (5) can be an adhesive tape, a magnetic strip more powerful than the platform (1), etc. It must be able to take signs (21) from platform (1) without relative movement between them but being possible to remove them again later.

Carrier (5) allows the indication (2) to be affixed again at the correct spot on the bodywork or any element of the vehicle, where it will be adhered with a strong adhesive or through the suitable method (which is not relevant). When the fixing is firm enough, carrier (5) may be removed, with indication (2) being perfectly affixed and with the exact kerning and alignment.

1. An auxiliary sheet-metal working device to secure the relative position of signs forming an indication to be positioned on the bodywork or any element of the vehicle, wherein the auxiliary sheet-metal working device comprises a flat platform with one or more rulers on at least one straight edge.

2. The auxiliary sheet-metal working device according to claim 1, wherein the platform is markable.

3. The auxiliary sheet-metal working device according to claim 1, wherein the platform has a magnetic surface.

4. The auxiliary sheet-metal working device according to claim 3, the magnetic surface of which has a force of between 50 and 300 Gauss.

5. The auxiliary sheet-metal working device according to claim 1, further comprising at least one movable ruler.

6. The auxiliary sheet-metal working device according to claim 1, further comprising at least one removable ruler.

7. The auxiliary sheet-metal working device according to claim 1, further comprising a mould with the negative of all or part of the signs of the indication.

8. The device according to claim 1, further comprising a carrier for the temporary fixing of indication.
